(19) United States
(12) Patent Application Publication
(10) Pub. No.: US 2026/0131670 A1
(43) Pub. Date: May 14, 2026

(54) ELECTRIC VEHICLE

(71) Applicant: TOYOTA JIDOSHA KABUSHIKI KAISHA, Toyota-shi (JP)

(72) Inventor: Junya HASEBE, Toyota-shi (JP)

(73) Assignee: TOYOTA JIDOSHA KABUSHIKI KAISHA, Toyota-shi (JP)

(21) Appl. No.: 19/383,029

(22) Filed: Nov. 7, 2025

(30) Foreign Application Priority Data
Nov. 11, 2024 (JP) 2024-196930

(51) Int. Cl. B60L 50/51; B60L 15/20; B60L 50/60; B60L 53/24; H02K 3/24

(52) U.S. Cl. CPC B60L 50/51; B60L 15/20; B60L 50/60; B60L 53/24; H02K 3/24; B60L 2210/42; B60L 2240/423; B60L 2240/425; B60L 2240/545

(57) ABSTRACT

An electric vehicle of the present disclosure includes a heat exchange system that transfers heat occurring in a three-phase alternating current motor to a battery, a coil cooling device configured to cool each of three-phase coils individually, and a controller that executes a heat generation control that controls the power control device such that direct current flows through each of the three-phase coils in response to satisfaction of a predetermined condition while the electric vehicle is stopped, and while the heat generation control is executed, controls the coil cooling device to cool the coil with a largest current flowing among the three-phase coils, and controls the power control device to increase the largest current. During the electric vehicle is stopped, it allows the three-phase alternating current motor to generate more heat while protecting the three-phase coils of the three-phase alternating current motor.

### CROSS-REFERENCE TO RELATED APPLICATION

The present disclosure claims priority to Japanese Patent Application No. 2024-196930 filed on Nov. 11, 2024, which is incorporated herein by reference in its entirety including specification, drawings and claims.

### TECHNICAL FIELD

The present disclosure relates to an electric vehicle with three-phase alternating current motor that includes three-phase coils connected at a neutral point and is configured to output power for driving.

### BACKGROUND

Conventionally known motor control device controls an alternating current motor that includes m stator coils wound on each of m teeth, in which one end of each stator coil is connected to an inverter and the other end is wired as a neutral point (see, for example, Patent Document 1). When the temperature of p stator coils is lower than that of the remaining (m−p) stator coils, the motor control device supplies alternating current with a phase difference of 360°/p and equal amplitude to the p stator coils, and supplies alternating current with a phase difference of 360°/(m−p) and equal amplitude to the remaining (m−p) coils. This allows the temperature of the stator coils to be equalized by passing more current through the stator coils with lower temperatures than those with higher temperatures, thereby improving the torque of the motor as a whole.

### CITATION LIST

### Patent Literature

[Patent Literature 1] Japanese Patent Application Laid Open No. 2010-206897

### SUMMARY

In a vehicle that is driven by power from the alternating current motor controlled by the above-mentioned conventional motor control device, a battery may be warmed up with heat from the alternating current motor by passing direct current through each stator coil such that total current flowing through m stator coils is zero when the vehicle is stopped. However, in this case, if the current flowing through the stator coils with low temperatures is increased in order to increase the heat from the alternating current motor, the increased current also flows through the stator coils with high temperatures. Therefore, it becomes necessary to set the increased amount of current in the stator coils with low temperatures so as to prevent the coils with high temperatures from burning out and the like, thereby making it difficult to generate a lot of heat in the alternating current motor. In addition, there is a risk of demagnetization due to heat conduction occurring in the vicinity of the stator coils with high temperatures.

A main object of the present disclosure is to allow a three-phase alternating current motor to generate more heat while protecting three-phase coils of the three-phase alternating current motor during an electric vehicle is stopped.

An electric vehicle of the present disclosure includes a three-phase alternating current motor, a battery, a power control device, a heat exchange system, a coil cooling device, and a controller. The three-phase alternating current motor includes three-phase coils connected at a neutral point and is configured to output power for driving. The power control device regulates electric power from the battery and supplies the electric power to the three-phase alternating current motor. The heat exchange system transfers heat occurring in the three-phase alternating current motor to the battery. The coil cooling device is configured to cool each of the three-phase coils individually. The controller executes a heat generation control that controls the power control device such that direct current flows through each of the three-phase coils in response to satisfaction of a predetermined condition while the electric vehicle is stopped. Further, while the heat generation control is executed, the controller controls the coil cooling device to cool the coil with a largest current flowing among the three-phase coils, and controls the power control device to increase the largest current.

This allows the coil through which the largest current of the three-phase coils is flowing to be cooled by the coil cooling device so as to prevent the coil from burning out and the like, while also preventing the remaining coils, through which the largest current is not flowing, from burning out and the like, thereby increasing the current flowing through each coil and facilitating heat generation in the three-phase alternating current motor. As a result, this allows more heat to be generated by the three-phase alternating current motor while protecting the three-phase coils of the three-phase alternating current motor during the electric vehicle is stopped. The heat generated by the three-phase alternating current motor is then transferred to the battery via the heat exchange system, thereby warming up the battery.

The predetermined condition may be satisfied when the temperature of the battery is equal to or less than a predetermined temperature. The battery may be configured to be charged with electric power from an external charging device. The controller may control the power control device such that the largest current becomes an upper limit current that does not cause the coil that is not cooled by the coil cooling device to burn out. Each of the three-phase coils may be hollowly formed, and the coil cooling device may be configured to supply refrigerant individually to each of the three-phase coils.

### BRIEF DESCRIPTION OF DRAWINGS

FIG. 1 is a schematic configuration diagram illustrating the electric vehicle of the present disclosure;

FIG. 2 is a schematic configuration diagram illustrating the stator of the three-phase alternating current motor of the the electric vehicle of the present disclosure;

FIG. 3 is a schematic configuration diagram illustrating the coil cooling device of the three-phase alternating current motor of the electric vehicle of the present disclosure;

FIG. 4 is a diagram explaining the heat generation control in the electric vehicle of the present disclosure; and

FIG. 5 is a flowchart showing a routine executed by the controller of the electric vehicle of the present disclosure.

### DESCRIPTION OF EMBODIMENTS

The following describes some aspects of the present disclosure with reference to drawings.

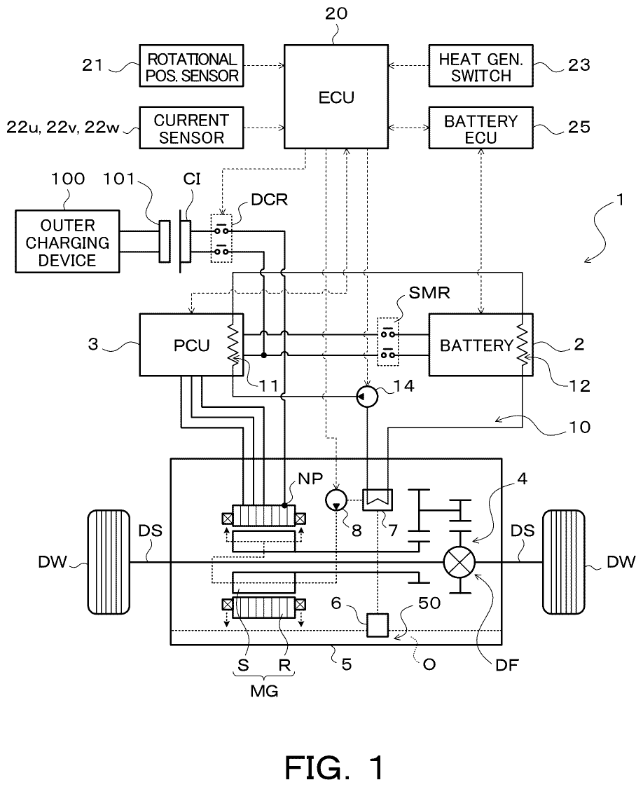

FIG. 1 is a schematic configuration diagram illustrating an electric vehicle 1 of the present disclosure. The electric vehicle 1 is a battery electric vehicle (BEV) that includes a motor-generator MG that drives a pair of drive wheels DW, a battery (energy storage device) 2, a power control unit (hereinafter referred to as ‘PCU’) 3 and an electronic control unit (hereinafter referred to as ‘ECU’) 20. The electric vehicle 1 may be a plug-in hybrid vehicle (PHV) or a non-plug-in hybrid vehicle (HEV) that includes an internal combustion engine (engine) in addition to the battery 2, the motor generator MG and the like.

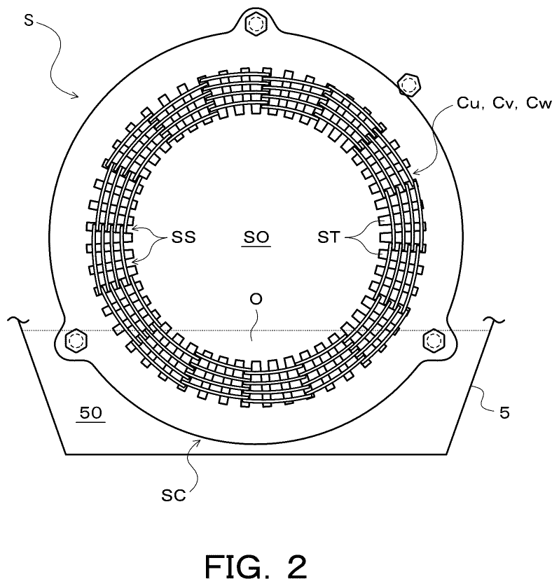

The motor generator MG is a three-phase alternating current motor (synchronous generator motor) that includes a stator S and a rotor R, and exchanges electric power with the battery 2 via the PCU 3. As shown in FIG. 2, the stator S of the motor generator MG includes an annular stator core SC, a stator coil Cu (U-phase coil), a stator coil Cv (V-phase coil), and a stator coil Cw (W-phase coil) (only one of the stator coils Cu, Cv, and Cw is shown in FIG. 2).

The stator core SC of the stator S is formed in an annular shape by laminating a plurality of electromagnetic steel plates formed in an approximate annular shape by pressing, for example, and connecting them in a laminated direction. The stator core SC may be formed into the annular shape by, for example, pressing and sintering ferromagnetic powder. The stator core SC includes a central hole SO in which the rotor R is disposed, a plurality of teeth ST that extend in a radial direction from an annular outer circumference portion (yoke portion) toward an axis and are disposed at a certain interval in a circumferential direction, and a plurality of slots SS (in this embodiment, for example, 48 slots) formed between adjacent teeth ST. The plurality of slots SS extend in the radial direction of the stator core SC and are arranged in a circumferential direction at a certain interval, and are opened at the central hole SO where the rotor R is disposed.

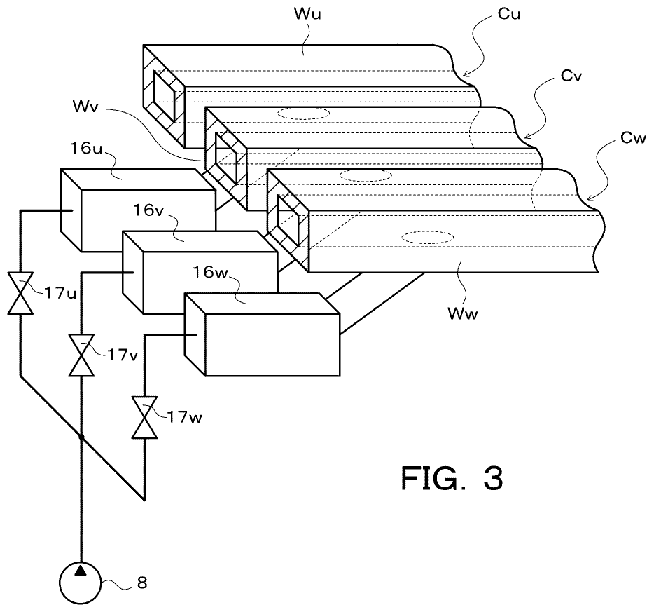

The stator coils Cu, Cv and Cw are wound on the stator core SC by passing coil wires through the corresponding multiple slots SS of the stator core SC, and are displaced in the circumferential direction. Further, one end (lead wire) of the stator coils Cu, Cv and Cw is connected to the corresponding power line, which is not shown in the figure, and the other end of the stator coils Cu, Cv and Cw is connected by star connection (Y connection) to form a neutral point NP. In this embodiment, the coil wire materials forming each stator coil Cu, Cv, Cw are hollow conductors Wu, Wv, Ww with an insulating coating made of enamel resin on the surface (see FIG. 3).

The battery 2 is a lithium-ion secondary battery or a nickel-metal hydride secondary battery, and the like, with a rated output voltage of around 200-800V, for example. The PCU 3 includes an inverter and a boost converter, and is connected to the battery 2 via a positive electric power line, a negative electric power line, and a system main relay SMR. The inverter of the PCU 3 includes, for example, six transistors (switching elements) and six diodes connected in parallel in reverse direction to each transistor. The inverter converts direct current power from the battery 2 into three-phase alternating current power to supply to the motor generator MG, and converts three-phase alternating current power from the motor generator MG into direct current power to supply to the battery 2.

In addition, the electric vehicle 1 includes a charging relay DCR and a charging inlet CI. The charging relay DCR is connected to the neutral point NP of the motor generator MG via an electric power line, and is also connected to the negative electric power line between the system main relay SMR and the PCU 3 via an electric power line. The charging inlet CI is disposed inside a charging lid of the electric vehicle 1 that is not shown in the figure, and is connected to the charging relay DCR via an electric power line. Thus, when both the system main relay SMR and the charging relay DCR are closed, the battery 2 is electrically connected to the charging inlet CI via the motor generator MG and the PCU 3.

When a charging connector 101 of an external charging device 100, for example a direct current type external charging device installed in an external charging facility such as a charging stand, is plugged into (connected to) a charging inlet CI, the battery 2 can be charged using the electric power from the external charging device 100. The charging relay DCR may be connected to the positive and negative electric power lines between the system main relay SMR and the PCU 3 via the electric power line. The electric vehicle 1 may be equipped with an in-vehicle charging device.

As shown in FIG. 1, the rotor R of the motor generator MG is connected to a pair of drive wheels DW via a reduction mechanism 4, a differential gear DF and the drive shafts DS. The motor generator MG, the reduction mechanism 4, the differential gear DF and part of each drive shaft DS are accommodated in a transaxle case 5, and configure a transaxle of the electric vehicle 1. In addition, an oil reservoir 50 is formed in a lower portion of the transaxle case 5 to reserve lubricating and cooling oil (lubricating and cooling medium) O. The lubricating and cooling oil O, which is scooped up by the gears included in the reduction mechanism 4 and differential gear DF, is supplied to the lubricating and cooling objects such as gears and bearings in the transaxle case 5 via oil passages, oil guides and the like that are not shown in the figure.

Further, in the electric vehicle 1, a strainer 6, a heat exchanger (cooler) 7, and an electric oil pump 8 are disposed in the transaxle case 5. The strainer 6 is fixed in the oil reservoir 50 such that a suction port at its bottom is opened downward. A suction port of the electric oil pump 8 is connected to an oil flow outlet of the strainer 6 via the heat exchanger 7. The lubricating and cooling oil O discharged from a discharge port of the electric oil pump 8 is supplied to the inside of the rotor R of the motor generator MG via oil passages or oil guide and the like that are not shown in the figure, and is also supplied to the stator S (coil ends) and bearings around the motor generator MG from the inside of the rotor R. After passing through the lubricating and cooling object such as the motor generator MG, the lubricating and cooling oil O flows down to the above-mentioned oil reservoir 50.

In this embodiment, part of the stator S of the motor generator MG, that is, part of the stator core SC (lower portion) and part of the stator coils Cu, Cv, and Cw, are immersed (submerged) in the lubricating and cooling oil O reserved in the oil reservoir 50, as shown in FIG. 2. Oil immersion ratio (number of slots SS through which the conductors Wu, Wv or Ww are passed) indicating degree of immersion of the stator coils Cu, Cv and Cw with respect to the lubricating cooling oil O stored in the oil reservoir 50 is determined according to an installation state of the stator S (motor generator MG) to the transaxle case 5. Then, the oil immersion ratio of one of the stator coils Cu, Cv, Cw (in this embodiment, for example, the stator coil Cu) becomes higher than the remaining two.

Furthermore, the electric vehicle 1 includes a heat exchange system 10 capable of transferring heat generated by the motor generator MG and the like in the transaxle case 5 to the battery 2, and a coil cooling device 15 capable of individually cooling the three-phase stator coils Cu, Cv, and Cw of the motor generator MG (stator S). The heat exchange system 10 includes a heat exchanger 7 in the transaxle case 5, a heat exchanger 11 provided in the PCU 3 (in the PCU case), a heat exchanger 12 provided in the battery 2 (in the battery case), and an electrically driven circulation pump 14 that circulates a heat transfer medium (coolant) between the heat exchangers 7, 11, and 12. By operating the circulation pump 14, the heat transfer medium that has absorbed heat from the motor generator MG and the PCU 3 through the heat exchangers 7 and 11 is supplied to the heat exchanger 12, and the heat is released from the heat transfer medium to the battery 2 in the heat exchanger 12.

The coil cooling device 15 includes the electric oil pump 8 in the transaxle case 5, a plurality (three) of oil jets 16u, 16v, 16w, and a plurality (three) of opening and closing valves 17u, 17v, 17w, as shown in FIG. 3. An oil inlet of each oil jet 16u, 16v, 16w is connected to the discharge port of the electric oil pump 8 via the corresponding opening and closing valves 17u, 17v or 17w. An oil outlet of each oil jet 16u, 16v, 16w is connected to the inside (oil passage) of the conductor Wu, Wv or Ww of the stator coil Cu, Cv or Cw via a relay pipe. Each oil jet 16u, 16v, 16w sprays (supplies) the lubricating and cooling oil O from the oil outlet into the inside of the corresponding conductor Wu, Wv or Ww when the pressure of the lubricating and cooling oil O supplied from the electric oil pump 8 to the oil inlet is higher than a predetermined pressure while the corresponding opening and closing valves 17u, 17v or 17w is open. The oil jets 16u, 16v, and 16w may be omitted from the coil cooling device 15, and the above-mentioned connecting pipes may be connected to the discharge port of the electric oil pump 8 via the opening and closing valves 17u, 17v, or 17w.

The ECU 20 includes a computer with a CPU, ROM, RAM, input/output interface and the like, various drive circuits, various logic ICs and the like, and controls (switching control) the inverter and the boost converter of the PCU 3. Further, the ECU 20 acquires an accelerator opening degree Acc, which indicates the amount of acceleration pedal depression detected by an accelerator pedal position sensor (not shown in the figure), a vehicle speed V detected by a vehicle speed sensor (not shown in the figure), a rotational position of the rotor R of the motor generator MG detected by a rotational position sensor (resolver) 21, phase currents Iu, Iv, Iw flowing through stator coils Cu, Cv, and Cw respectively detected by current sensors 22u, 22v, and 22w, and the like. Furthermore, the ECU 20 acquires SOC (state of charge) of the battery 2, an allowable charging power Win (negative value) and an allowable discharging power Wout (positive value) respectively calculated by a battery electronic control unit (hereinafter referred to as the ‘battery ECU’) 25 that manages the battery 2, temperature (representative temperature) Tb of the battery 2 detected by a temperature sensor not shown in the figure, and the like.

When the electric vehicle 1 is driven, the ECU 20 calculates an electrical angle θe and a rotation speed Nm of the motor generator MG (rotor R) based on the rotational position of the rotor R. Further, the ECU 20 sets a torque command Tm* to the motor generator MG in accordance with a required torque for driving the electric vehicle 1 based on the accelerator opening degree Acc and the vehicle speed V within the allowable charging power Win and the allowable discharging power Wout of the battery 2, and controls the switching of the inverter (multiple transistors) and the like of the PCU 3 based on the torque command Tm*. When the electric vehicle 1 is braked, the ECU 20 controls the PCU 3 such that the motor generator MG outputs regenerative braking torque (torque command Tm*) to the pair of drive wheels DW within the allowable charging power Win and the allowable discharging power Wout of the battery 2.

When controlling the switching of the inverter (multiple transistors) of PCU 3, the ECU 20 calculates currents Id and Iq in d-axis and q-axis by coordinate transformation (3-phase to 2-phase transformation) of the phase currents Iu, Iv, and Iw based on separately calculated electrical angle θe. The ECU 20 then sets current commands Id* and Iq* for the d-axis and q-axis based on the torque command Tm*, and calculates voltage commands Vd* and Vq* for the d-axis and q-axis such that a difference between the current commands Id* and Iq* and the currents Id and Iq is cancelled out by current feedback control. Furthermore, the ECU 20 executes a coordinate transformation (2-phase to 3-phase transformation) of the voltage commands Vd* and Vq* for the d-axis and q-axis into the voltage commands Vu*, Vv*, and Vw* based on the electrical angle θe. Then, by comparing the voltage commands Vu*, Vv*, and Vw* with a carrier wave (triangular wave), PWM signals are generated for the multiple transistors of the inverter, and the switching control of the multiple transistors is executed using the generated PWM signals.

Further, when charging the battery 2 using the electric power (direct current) from the external charging device 100, the ECU 20 controls the opening and closing of the charging relay DCR, and also makes the three-phase stator coils Cu, Cv, and Cw of the motor generator MG and each phase of the inverter of the PCU 3 function as a multi-phase boost converter. This allows the electric power (direct current) supplied to the charging inlet CI to be boosted by the multi-phase step-up converter, and the battery 2 to be charged with the boosted electric power.

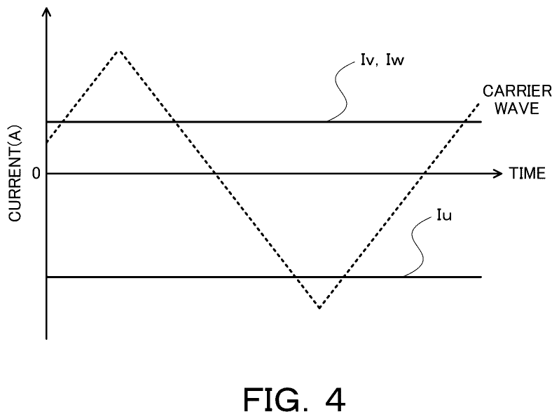

Furthermore, the ECU 20 controls the electric oil pump 8 in the transaxle case 5 and the circulation pump 14 of the heat exchange system 10, and also controls the opening and closing of the opening and closing valves 17u, 17v, 17w of the coil cooling device 15. In addition, the ECU 20 executes a heat generation control to warm up the battery 2 as necessary while the electric vehicle 1 is stopped, and controls the electric oil pump 8 in the transaxle case 5 and the circulation pump 14 of the heat exchange system 10. The heat generation control, as shown in FIG. 4, applies direct current to each of the stator coils Cu, Cv, and Cw of the motor generator MG, and controls the inverter of the PCU 3 such that the total current flowing through the three-phase stator coils Cu, Cv, and Cw becomes zero. By executing the heat generation control, the stator coils Cu, Cv and Cw of the motor generator MG are made to generate heat, and the heat from the motor generator MG is transferred to the battery 2 via the lubricating and cooling oil O and the heat transfer medium of the heat exchange system 10, thereby enabling the battery 2 to be warmed up. Further, a heat generation switch 23 is connected to the ECU 20, and the driver of the electric vehicle 1 is allowed to permit or prohibit the execution of heat generation control by operating the heat generation switch 23. The ECU 20 sets the heat generation flag to ‘1’ when the heat generation switch 23 is turned on, and sets the heat generation flag to ‘0’ when the heat generation switch 23 is turned off. The functions of the ECU 20 described above may be distributed across multiple electronic control units.

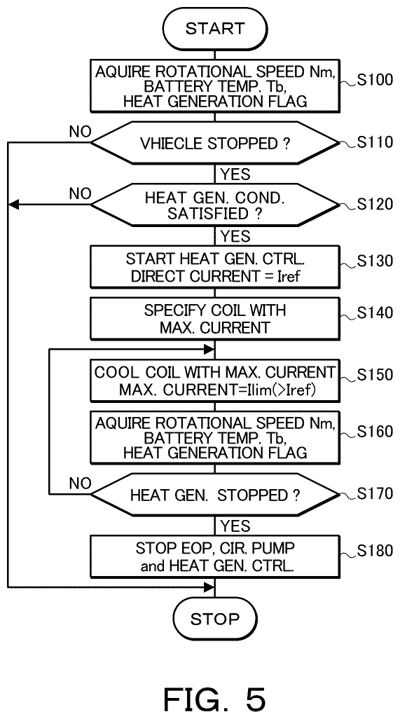

Next, referring to FIG. 5, an explanation will be given of operations related to the heat generation control of electric vehicle 1. FIG. 5 is a flowchart showing a routine that is executed at predetermined intervals by the ECU 20 while the electric vehicle 1 is in operation.

When the timing for the execution of the routine of FIG. 5 arrives, the ECU 20 acquires a rotational speed Nm of the motor generator MG, a temperature Tb of the battery 2, and a value of a heat generation flag (step S100). The ECU 20 then determines whether or not the electric vehicle 1 is stopped based on the rotational speed Nm of the motor generator MG acquired in step S100 (step S110). In step S110, the ECU 20 determines that the electric vehicle 1 is stopped when the rotational speed Nm is zero, and determines that the electric vehicle 1 is not stopped when the rotational speed Nm is not zero. When the rotational speed Nm is not zero and the electric vehicle 1 is not stopped (step S110: NO), the ECU 20 terminates the routine of FIG. 5 at that point. The processing of step S110 may be to determine whether the electric vehicle 1 is stopped or not based on the vehicle speed V, a detected value of the rotational position sensor 21, a gradient of a carrier wave of the U, V, and W phases, or the like.

When the electric vehicle 1 is stopped (step S110: YES), the ECU 20 determines whether or not an execution conditions for the above heat generation control are satisfied based on the temperature Tb of the battery 2 and the value of the heat generation flag acquired in step S100 (step S120). In step S120, the ECU 20 determines that the execution conditions for the heat generation control are satisfied when the temperature Tb of the battery 2 is equal to or lower than a predetermined heat generation execution temperature (for example, 0° C.) and the heat generation switch 23 is turned on and the above heat generation flag is set to ‘1’. In step S120, when the temperature Tb of the battery 2 exceeds the heat generation execution temperature, or when the heat generation switch 23 is turned off and the above heat generation flag is set to ‘0’, the ECU 20 determines that the execution conditions for heat generation control are not satisfied. When the execution conditions for heat generation control are not satisfied (step S120: NO), the ECU 20 terminates the routine of FIG. 5 at that point.

When the execution conditions for heat generation control are satisfied (step S120: YES), the ECU 20 controls the PCU 3 (inverter) so as to apply a predetermined relatively low direct current Iref (Arms) to one of the stator coils Cu, Cv, and Cw, thereby starting the heat generation control (step S130). The direct current Iref is a constant value that is smaller than an upper limit current Ilim (Arms) that is acquired in advance as a current that does not burn out the stator coils Cu, Cv, Cw (conductors Wu, Wv, Ww). The upper limit current Ilim is a current (positive value) that does not burn out the stator coils Cu, Cv, and Cw when they are not cooled by the lubricating and cooling oil O reserved in the oil reservoir 50, the lubricating and cooling oil O from the electric oil pump 8, and the lubricating and cooling oil O from the coil cooling device 15. When the direct current Iref flows through one of the stators (coils) Cu, Cv, and Cw, approximately equal currents flow through the remaining two stators such that the total current of the three phases becomes zero.

After starting the heat generation control in step S130, the ECU 20 acquires the phase currents Iu, Iv, and Iw detected by the current sensors 22u, 22v, and 22w, and specifies one of the stator coils Cu, Cv, and Cw through which the current with a largest absolute value (largest current) is flowing based on the acquired phase currents Iu, Iv, and Iw (step S140). The processing in step S140 may specify one of the stator coils Cu, Cv, and Cw with the largest absolute value of current flowing through it, based on a single-sided amplitude of the carrier wave of the U, V, and W phases, instead of the phase currents Iu, Iv, and Iw.

Then, the ECU 20 controls the coil cooling device 15 to cool (only) the stator coil Cu, Cv, or Cw through which the current with the largest absolute value is flowing, which is specified in step S140, and activates the circulation pump 14 of the heat exchange system 10 (step S150). Further, in step S150, the ECU 20 controls the PCU 3 (inverter) such that the absolute value of the current flowing through the stator coil Cu, Cv or Cw specified in step S140 becomes equal to the above-mentioned upper limit current Ilim, thereby continuing the heat generation control.

That is, in step S150, the ECU 20 opens the opening and closing valve 17u, 17v, or 17w corresponding to the stator coil Cu, Cv, or Cw through which the current with the largest absolute value is flowing. In addition, the ECU 20 controls the electric oil pump 8 such that a discharge pressure becomes the above-mentioned predetermined pressure, and controls the circulation pump 14 such that the heat medium circulates between the heat exchangers 7, 11, and 12. Furthermore, in step S150, the ECU 20 increases the d-axis current command Id* and the q-axis current command Iq* in accordance with a difference between the direct current Iref and the upper limit current Ilim, and controls the PCU 3 (inverter) based on the current commands Id* and Iq*. This allows the motor generator MG, that is, the three-phase stator coils Cu, Cv and Cw, to generate more heat. The heat generated by the motor generator MG is recovered by the lubricating and cooling oil O discharged from the electric oil pump 8 and the lubricating and cooling oil O supplied to the relevant stator coils Cu, Cv or Cw from the coil cooling device 15, and is transferred from the lubricating and cooling oil O to the coolant of the heat exchange system 10 in the heat exchanger 7. Furthermore, the coolant passes through the heat exchanger 11 of the PCU 3 and is pumped to the heat exchanger 12 of the battery 2. As a result, the heat generated by the motor generator MG and the PCU 3 is transferred to the battery 2 via the coolant, thereby enabling the battery 2 to be warmed up satisfactorily.

After the processing in step S150, the ECU 20 acquires the rotational speed Nm of the motor generator MG, the temperature Tb of the battery 2, and the value of the heat generation flag (step S160), and then determines whether or not to stop the heat generation control based on the acquired rotational speed Nm, the temperature Tb, and the value of the heat generation flag (step S170). The ECU 20 determines that the heat generation control should be continued when the rotational speed Nm is zero and the electric vehicle 1 is stopped, the temperature Tb of the battery 2 is lower than a heat generation stop temperature that is slightly higher than the above heat generation execution temperature, and the heat generation switch 23 is turned on and the heat generation flag is set to ‘1’ (step S170: NO). In this case, the ECU 20 executes the processing of steps S150 to S170 again. The processing of step S170 may be to determine whether the vehicle is stopped or not based on the vehicle speed V, the detected value of the rotational position sensor 21, or the gradient of the carrier wave of the U, V, and W phases.

When the rotational speed Nm is not zero and the electric vehicle 1 is started, when the temperature Tb of the battery 2 is equal to or higher than the heat generation stop temperature, or when the heat generation switch 23 is turned off and the heat generation flag is set to ‘0’, the ECU 20 determines that the heat generation control should be stopped (step S170: YES). In these cases, the ECU 20 stops the electric oil pump 8 and the circulation pump 14, and closes the opening and closing valves 17u, 17v, or 17w to stop the cooling by the coil cooling device 15 and the circulation of the coolant (step S180). Further, the ECU 20 stops the heat generation control at step S180 and terminates the routine of FIG. 5.

As has been described above, the electric vehicle 1 includes the motor generator MG, the battery 2, the PCU 3 (inverter), the heat exchange system 10, the coil cooling device 15, and the ECU 20 as a controller. The motor generator MG includes the three-phase stator coils Cu, Cv, and Cw, which are connected at the neutral point NP, and is capable of outputting the power for driving. The PCU 3 (inverter) regulates the electric power from the battery 2 and supplies the electric power to the motor generator MG. The heat exchange system 10 is capable of transferring the heat occurred in the motor generator MG to the battery 2. The coil cooling device 15 is capable of cooling the three-phase stator coils Cu, Cv, and Cw individually. The ECU 20 executes the heat generation control, which controls the PCU 3 (inverter) such that the direct current flows through each of the three-phase stator coils Cu, Cv, and Cw in response to the satisfaction of the execution conditions (predetermined conditions) of the heat generation (step S120: YES, S130), while the electric vehicle 1 is stopped (step S110: YES). Further, while the heat generation control is executed, the ECU 20 controls the coil cooling device 15 to cool the stator coil Cu, Cv, or Cw with the current of the absolute value largest among the three-phase stator coils Cu, Cv, and Cw, and controls the PCU 3 (inverter) such that the said largest current increases (the absolute value increases) (steps S140-S160, S170: NO).

This allows the stator coil Cu, Cv or Cw with the largest absolute value of current among the three-phase stator coils Cu, Cv and Cw to be cooled by the coil cooling device 15 so as to prevent the stator coil Cu, etc. from burning out. Further, while preventing the remaining stator coils CV, CW, etc., through which the largest current does not flow, from burning out, the current (absolute value) flowing through each stator coil Cu, Cv, Cw is increased to facilitate heat generation in the motor generator MG. As a result, this allows more heat to be generated by the motor generator MG while protecting the three-phase stator coils Cu, Cv and Cw of the motor generator MG when the electric vehicle 1 is stopped. In the electric vehicle 1, the heat generated by the motor generator MG can be transferred to the battery 2 via the heat exchange system 10 to warm up the battery 2.

Further, in the electric vehicle 1, the execution condition for the heat generation is satisfied when the temperature Tb of the battery 2 is equal to or lower than the predetermined heat generation temperature (predetermined temperature) (step S120). This allows the battery 2 to be warmed up using the time when the electric vehicle 1 is stopped, thereby protecting the battery 2 and suppressing prolongation of charging time of the battery 2.

Furthermore, the battery 2 can be charged with the electric power from the external charging device 100 of the external charging facility. This allows the battery 2 to be warmed up before the charging with the electric power from the external charging device 100 starts, using a stop time until the electric vehicle 1 arrives at the external charging facility, thereby suppressing the prolongation of the charging time in the external charging facility.

In addition, the ECU 20 controls the PCU 3 (inverter) such that the absolute value of the above-mentioned largest current becomes the upper limit current Ilim that does not burn out the stator coils Cv, Cw or the like that are not cooled by the coil cooling device 15 (step S150). This allows the largest current to be increased (absolute value to be increased) while more reliably preventing the burning out and the like of all three-phase stator coils Cu, Cv, Cw.

Furthermore, in the electric vehicle 1, each of the conductors Wu, Wv, and Ww that form the three-phase stator coils Cu, Cv, and Cw is hollow, and the coil cooling device 15 is capable of supplying refrigerant individually to the inside of each of the three-phase stator coils Cu, Cv, and Cw. This allows the three-phase stator coils Cu, Cv and Cw to be cooled individually. However, the coil cooling device 15 may be configured to supply the refrigerant to the slots SS of the stator cores SC corresponding to each of the three-phase stator coils Cu, Cv and Cw.

The disclosure is not limited to the above embodiments in any sense but may be changed, altered or modified in various ways within the scope of extension of the disclosure. Additionally, the embodiments described above are only concrete examples of some aspect of the disclosure described in Summary and are not intended to limit the elements of the disclosure described in Summary.

### INDUSTRIAL APPLICABILITY

The technique of the present disclosure is applicable to, for example, the manufacturing industry of the electric vehicle.

1. An electric vehicle comprising:
a three-phase alternating current motor that includes three-phase coils connected at a neutral point and is configured to output power for driving;
a battery;
a power control device that regulates electric power from the battery and supplies the electric power to the three-phase alternating current motor;
a heat exchange system that transfers heat occurring in the three-phase alternating current motor to the battery;
a coil cooling device configured to cool each of the three-phase coils individually; and
a controller that executes a heat generation control that controls the power control device such that direct current flows through each of the three-phase coils in response to satisfaction of a predetermined condition while the electric vehicle is stopped, and while the heat generation control is executed, controls the coil cooling device to cool the coil with a largest current flowing among the three-phase coils, and controls the power control device to increase the largest current.

2. The electric vehicle according to claim 1, wherein:
the predetermined condition is satisfied when the temperature of the battery is equal to or less than a predetermined temperature.

3. The electric vehicle according to claim 1, wherein:
the battery is configured to be charged with electric power from an external charging device.

4. The electric vehicle according to claim 1, wherein:
the controller controls the power control device such that the largest current becomes an upper limit current that does not cause the coil that is not cooled by the coil cooling device to burn out.

5. The electric vehicle according to claim 1, wherein:
each of the three-phase coils is hollowly formed; and
the coil cooling device is configured to supply refrigerant individually to each of the three-phase coils.
